(19) United States
(12) Patent Application Publication
(10) Pub. No.: US 2009/0022352 A1
(43) Pub. Date: Jan. 22, 2009

(54) EARBUD KEEPER

(75) Inventor: William Albert Weibel, Orinda, CA (US)

Correspondence Address: HAYNES BEFFEL & WOLFELD LLP, P O BOX 366, HALF MOON BAY, CA, 94019, US

(73) Assignee: Intuitive Devices, Inc., Los Gatos, CA (US)

(21) Appl. No.: 12/175,862

(22) Filed: Jul. 18, 2008

Related U.S. Application Data
(60) Provisional application No. 60/951,030, filed on Jul. 20, 2007.

(51) Int. Cl. H04R 1/10

(52) U.S. Cl. 381/378

(57) ABSTRACT

An ear-mounted audio device keeper includes a retainer, having has first and second ends, and a clip assembly at the first end, the clip assembly securable to an ear-mounted audio device. Each clip assembly can at least partially encircle and be secured to the ear-mounted audio device. The retainer can include a flexible but not stiff leash or a flexible, resilient headband. Some examples comprise a clip assembly at both the first and second ends, each clip assembly securable to an ear-mounted audio device, such as an earbud earphone. The audio device keeper can be used to maintain control over earbud earphones with the leash placed on one side of the user's neck and audio wires are placed on the other side of the user's neck.

### CROSS-REFERENCE TO OTHER APPLICATIONS

This application claims the benefit of U.S. provisional patent application No. 60/951,030 filed 20 Jul. 2007.

### BACKGROUND OF THE INVENTION

Small media storage devices are becoming increasingly common for storing and playing audio recordings, such as songs and other musical compositions, books, video recordings, and other electronic media including text as well as audiovisual information. One of the most popular, if not the most popular, is the iPod® digital music, and other digital media, player. It is often listened to using earbuds, that is small earphones worn in the ear.

### BRIEF SUMMARY OF THE INVENTION

An example of ear-mounted audio device keeper includes a retainer and a clip assembly. The retainer has first and second ends sized to extend at least halfway around a user's head. The clip assembly is at the first end and is securable to an ear-mounted audio device. Each clip assembly comprises a portion configured to at least partially encircle and be secured to the ear-mounted audio device. In some examples the retainer comprises a flexible but not stiff leash. In some examples the retainer comprises a flexible, resilient headband. Some examples comprise a clip assembly at both the first and second ends, each clip assembly securable to an ear-mounted audio device.

An example of an earbud assembly includes earbud earphones and an earbud keeper. The earbud earphones comprises first and second earbuds and audio wires extending from the first and second earbuds. The earbud keeper includes a flexible leash and first and second clip assemblies. The flexible leash has first and second ends and is sized to fit at least halfway around the user's head. The first and second clip assemblies are securable to the first and second earbuds or to the audio wires at or near the first and second earbuds. Each clip assembly comprises a portion configured to at least partially encircle the part of the earbud earphones to which it is secured.

An example of a method for maintaining control over earbud earphones, of the type comprising first and second earbuds and audio wires extending from the first and second earbuds, is carried out as follows. An earbud keeper, comprising a flexible leash having first and second ends securable to the first and second earbuds, is obtained. The first and second ends of the flexible leash are secured to the first and second earbuds. The flexible leash is placed on one side of the user's neck. The earbuds are secured to the user's ears. The audio wires are placed on the other side of the user's neck. In some examples the effective length of the flexible leash is adjusted.

Other features, aspects and advantages of the present invention can be seen on review the figures, the detailed description, and the claims which follow.

### BRIEF DESCRIPTION OF THE DRAWINGS

FIG. 1 is a view from the back of the head illustrating an earbud keeper secured to the earbuds of the earbud earphones worn by a user;

FIG. 2 is an enlarged side view of the clip assembly and earbud of FIG. 1;

FIG. 3 is a front view of the structure of FIG. 2;

FIG. 4 shows the structure of FIG. 2 with the clip base separated from the clip;

FIGS. 5 and 6 show mounting of the clip of FIGS. 1-4 on to the shaft portion of the earbud;

FIGS. 7, 8 illustrate an alternative embodiment of a clip assembly in which a loop is placed over the speaker portion of the earbud and then tightened onto the shaft portion of the earbud;

FIGS. 9 and 10 show a further alternative embodiment of a clip assembly in which the clip includes an alligator-type clip including a clamp to secure the clip assembly to the earbud;

FIG. 11 is a view similar to that of FIG. 1 showing the use of a slide-type tensioner to remove the slack in the leash; and

FIG. 12 is a side view of another example of the invention in which the generally limp, pliant leash of the earbud keeper of FIG. 1 is replaced by a flexible headband.

### DETAILED DESCRIPTION OF THE INVENTION

The following description will typically be with reference to specific structural embodiments and methods. It is to be understood that there is no intention to limit the invention to the specifically disclosed embodiments and methods but that the invention may be practiced using other features, elements, methods and embodiments. Preferred embodiments are described to illustrate the present invention, not to limit its scope, which is defined by the claims. Those of ordinary skill in the art will recognize a variety of equivalent variations on the description that follows. Like elements in various embodiments are commonly referred to with like reference numerals.

One example of the invention is directed to an accessory for use with earbud earphones. Conventional earbud earphones include earbuds, which are worn in the ear, connected to, for example, a digital music player, by audio wires. The invention has particular utility for use with earbuds designed for use with iPod® digital media players and iPhone® telephones. A complaint with earbuds is that they may not fit properly, and therefore are they may keep falling out. Another complaint is that the audio wires must often be untangled before placing the earbuds in the ears. The accessory, called the earbud keeper, helps to keep earbuds tangle free and under control at all times. In particular, the earbud keeper helps keep the earbuds tangle free and under control while enjoying a variety of different activities, including jogging, walking, biking, hiking, skating, skateboarding and camping. If the earbuds fall out or they are taken out on purpose, the earbud keeper keeps the earbuds in reach and under control. The earbuds do not just fall to the ground but rather they stay conveniently in reach, typically at about shoulder height. This is useful for users of all ages and can be especially useful for persons with mobility issues. The earbud keeper also helps prevent earbuds from failing prematurely due to stresses placed on the wires when they fall down or dangle.

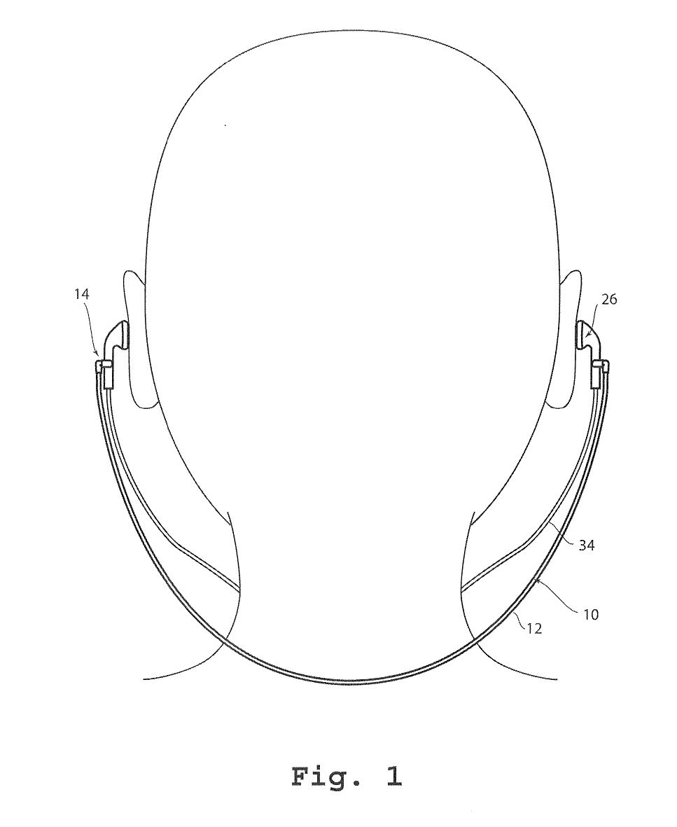

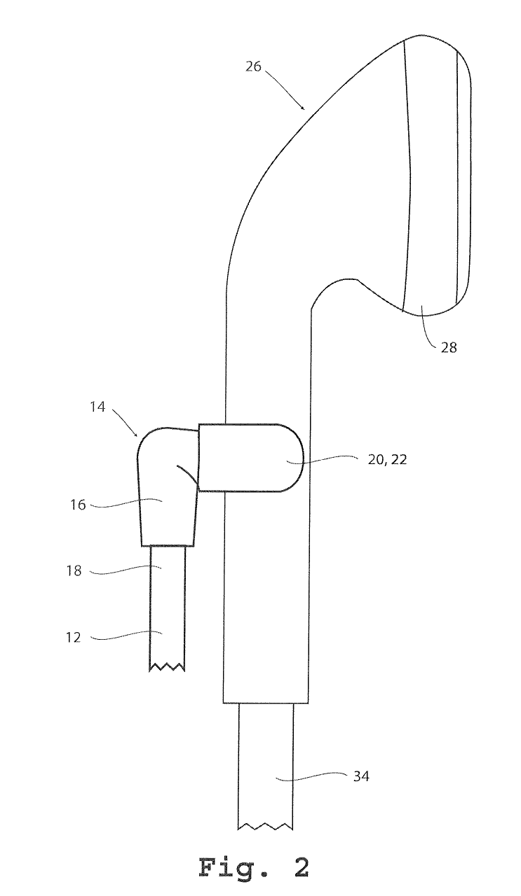

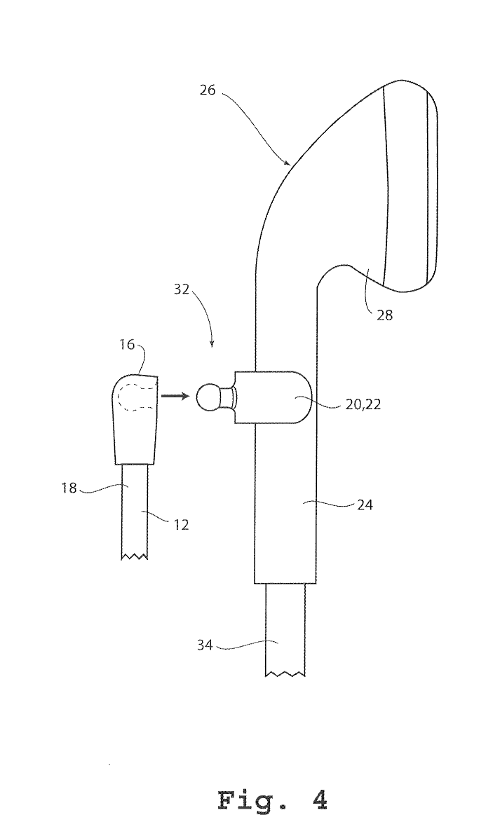

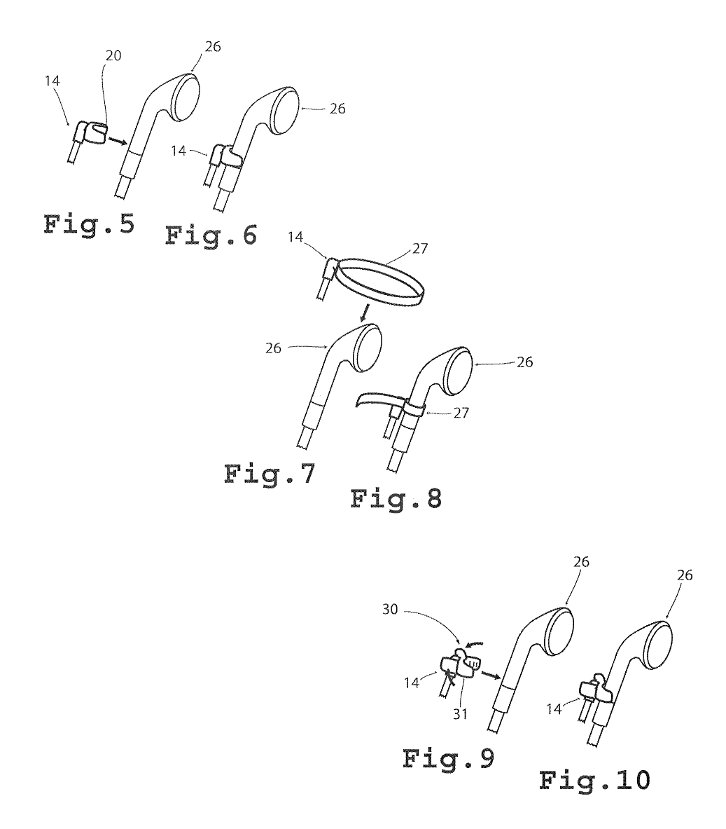

As shown in FIGS. 1-4, the earbud keeper 10 includes a retainer 12, such as a flexible, but not stiff, leash 12, having a clip assembly 14 at either end. Leash 12 could be a length of plastic-covered wire, a strand of woven material, or a length of other materials suitable for wearing around one's neck. Each clip assembly 14 includes a clip base 16, secured to each end 18 of the leash 12, and an attachment element 20, typically referred to as a clip 20. The clip 20, in this example, has a pair of resilient arms 22 configured to partially encircle the shaft portion 24 of a conventional, or unconventional, earbud 26. This permits the clip assembly 14 to be conveniently secured to and removed from the earbud 26. See FIGS. 5 and 6. Instead of resilient arms 22, the clip 20 could be in the form of a loop design including a loop 27, see FIGS. 7 and 8, that can be passed over the enlarged speaker portion 28 of the earbud 26 and cinched tightly onto the earbud shaft portion 24. Also, clip 20 can be an alligator-type of clip 20 including a clamp 30 with spring-biased arms 31 configured to close around the earbud shaft portion 24. This is shown in FIGS. 9 and 10. Clip 20 can also be designed to be secured to the earbud audio wires 34, typically at or adjacent to earbuds 26, instead of directly to earbuds 26; such a clip would be designed so not to damage the earbud audio wires, such as through the use of cushioned jaws or otherwise.

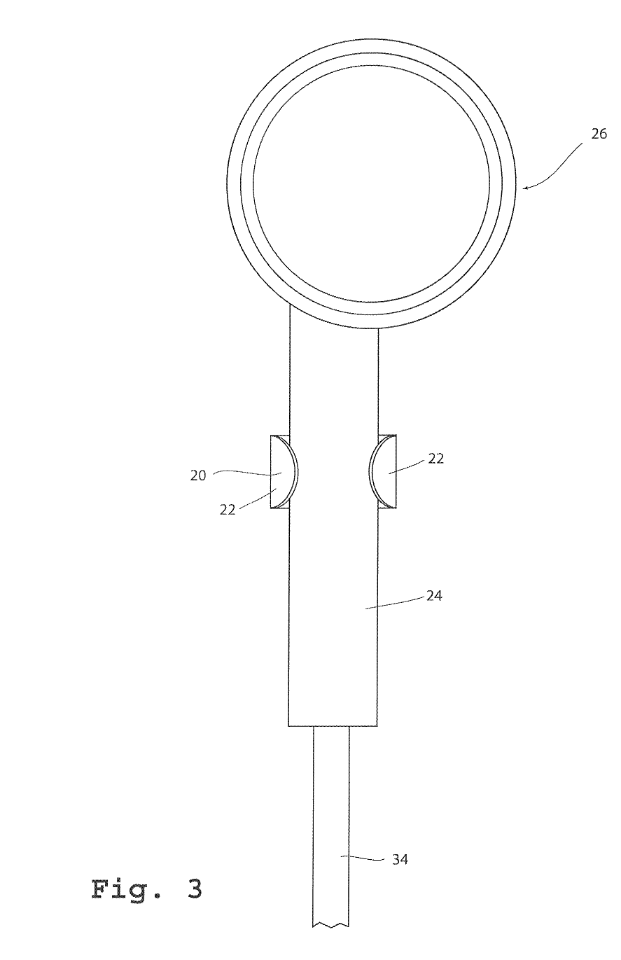

In the example illustrated in FIG. 4, the clip 20 and clip base 16 are preferably secured to one another with a movable or flexible joint 32, such as the ball and socket joint illustrated. Instead of a ball and socket type of joint, the joint could be, for example, a magnetic coupling or a micro squeeze clip commonly seen on jewelry. Use of ball and socket joint 32, or other appropriate joint, helps to ensure that the earbud keeper 10 does not exert undesirable levels of forces on the earbuds 26 or the earbud audio wires 34. It also permits the earbud keeper 10 to be used with different earbuds; properly sized and configured clips for the particular earbuds can be provided. For example, a set of extra clips of different sizes can be provided with each earbud keeper to allow the earbud keeper to be used with a variety of brands of earbuds by simply replacing the original clip with a substitute clip suitable for the particular earbud or audio wire being used. Different color leashes and/or earbuds can also be used to, for example, match or complement the most popular iPod® colors, or for any other reason.

When the earbud audio wires 34 are routed in front of the user, as shown in FIG. 1, the leash 12 of the earbud keeper 10 can be placed behind the user's neck so that if an earbud 26 is pulled out or is removed from the user's ear, the earbud remains easily accessible, typically at about shoulder height. The reverse orientation with the earbud audio wires 34 routed in back of the user and the leash 12 at the front of the user can also be used. Having the leash 12 and the earbud audio wires 34 on the same side of the user is typically less desirable because a single removed earbud can hang down farther and thus be less accessible to the user; the same side of the user orientation would also make earbud keeper 10 much less effective at maintaining control of the earbuds if they both become dislodged from the ear.

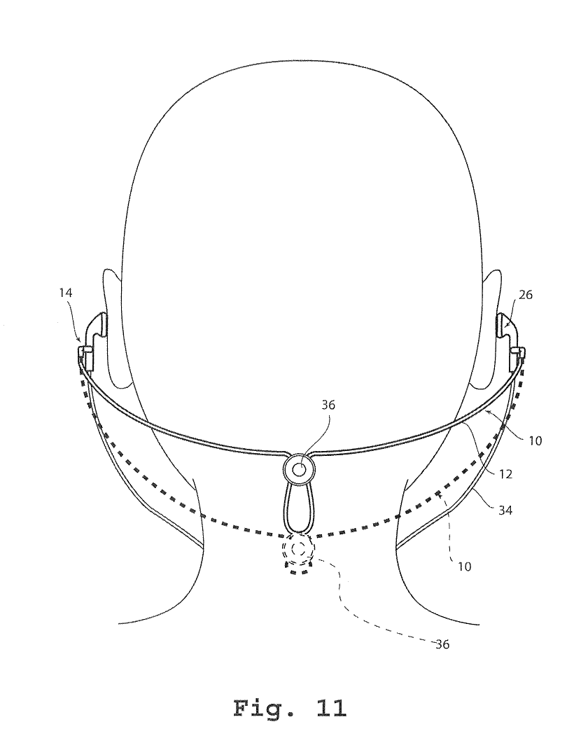

Instead of the one size fits all type of leash as shown in FIG. 1, the leash could be a variable length leash. One way to do so, see FIG. 11, is to use a slide-type tensioner 36 to adjust the effective length of the leash 12. Instead of slide-type tensioner 36, a retractable tensioner, which preferably allows part or the entire leash to be housed within the tensioner body and then pulled out to the desired length, can be used.

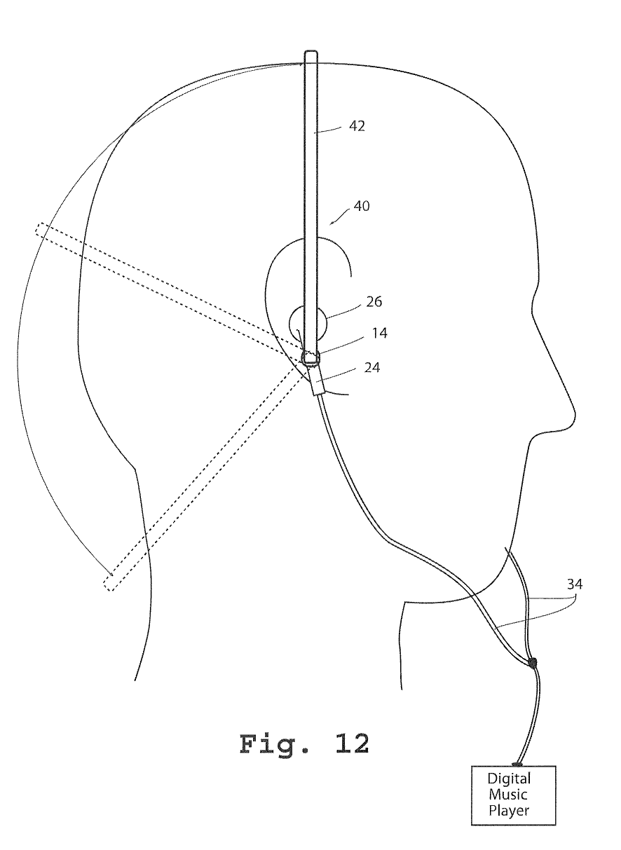

FIG. 12 illustrates a headband type of earbud keeper 40 similar to earbud keeper 10 but instead of flexible leash 12, earbud keeper 40 uses a retainer 12 in the form of a flexible, resilient headband 42. Headband 42 has a clip assembly 14 at either end. Clip assemblies 14 are typically designed for securement to earbuds 26 but maybe designed for securement to audio wires 34. As suggested in FIG. 12, headband 42 can be worn on top of a user's head or pivoted rearward to be placed behind the user's head or neck. In addition to helping to control earbud earphones once dislodged from the user's ears, headband 42 can provide an inwardly directed force to help keep the earbuds 26 properly placed against the user's ears. Earbud keeper 40 can also be used when only a single ear-mounted audio device, such as an earbud or a wireless headphone, is used with one ear; in such case earbud keeper 40 may include a clip assembly 14 at only one end or earbud keeper 40 could be provided with a comfort-enhancing pad to which the unused clip assembly can be secured.

The above descriptions may have used terms such as above, below, top, bottom, over, under, et cetera. These terms may be used in the description and claims to aid understanding of the invention and not used in a limiting sense.

While the present invention is disclosed by reference to the preferred embodiments and examples detailed above, it is to be understood that these examples are intended in an illustrative rather than in a limiting sense. It is contemplated that modifications and combinations will occur to those skilled in the art, which modifications and combinations will be within the spirit of the invention and the scope of the following claims.

Any and all patents, patent applications and printed publications referred to above are incorporated by reference.

1. An ear-mounted audio device keeper comprising:
a retainer, having first and second ends sized to extend at least halfway around a user's head;
a clip assembly at the first end securable to an ear-mounted audio device; and
each clip assembly comprising a portion configured to at least partially encircle and be secured to the ear-mounted audio device.

2. The audio device keeper according to claim 1 wherein the retainer comprises a flexible but not stiff leash.

3. The audio device keeper according to claim 1 wherein the retainer comprises a flexible, resilient headband.

4. The audio device keeper according to claim 1 further comprising a clip assembly at both the first and second ends, each clip assembly securable to an ear-mounted audio device.

5. The audio device keeper according to claim 1 wherein the clip assembly comprises a clip base and a movable joint securing the clip to the clip base.

6. The audio device keeper according to claim 1 wherein the clip assembly comprises a loop placeable over and tightenable onto the ear-mounted audio device.

7. The audio device keeper according to claim 1 wherein the clip assembly comprises a clamp securable to the earbud.

8. The audio device keeper according to claim 2 wherein the flexible leash is an adjustable effective length leash.

9. The audio device keeper according to claim 8 wherein the adjustable effective length leash comprises a tension device.

10. The audio device keeper according to claim 1 wherein the clip assembly is securable to a wire.

11. An earbud assembly comprising:
earbud earphones comprising first and second earbuds and audio wires extending from the first and second earbuds; and
an earbud keeper comprising:
a flexible leash, having first and second ends, sized to fit at least halfway around the user's head;
first and second clip assemblies at the first and second ends securable to the first and second earbuds or to the audio wires at or near the first and second earbuds; and
each clip assembly comprising a portion configured to at least partially encircle the part of the earbud earphones to which it is secured.

12. The earbud assembly according to claim 11 wherein each earbud comprises a speaker portion and a shaft portion.

13. The earbud assembly according to claim 12 wherein the clip assemblies are releasably securable to the shaft portions of the earbuds.

14. The earbud assembly according to claim 11 wherein the clip assemblies are releasably securable to the audio wires.

15. The earbud assembly according to claim 11 wherein each clip assembly comprises a clip base and a movable joint securing the clip to the clip base.

16. The earbud assembly according to claim 11 wherein each clip assembly comprises a loop placeable over and tightenable onto said part of the earbud earphones.

17. The earbud assembly according to claim 11 wherein each clip assembly comprises a clamp securable to said part of the earbud earphones.

18. The earbud assembly according to claim 11 wherein the flexible leash is an adjustable effective length leash.

19. The earbud keeper according to claim 18 wherein the adjustable effective length leash comprises a slide type tensioner.

20. A method for maintaining control over earbud earphones of the type comprising first and second earbuds and audio wires extending from the first and second earbuds, the method comprising:
obtaining an earbud keeper comprising a flexible leash having first and second ends securable to the first and second earbuds;
securing the first and second ends of the flexible leash to the first and second earbuds;
placing the flexible leash on one side of the user's neck;
securing the earbuds to the user's ears; and
placing the audio wires on the other side of the user's neck.

21. The method according to claim 20 wherein:
the earbud keeper obtaining step comprises obtaining an earbud keeper comprising first and second clip assemblies at the first and second ends; and
the first and second ends securing step comprises releasably securing the first and second clip assemblies to the first and second earbuds.

22. The method according to claim 20 further comprising adjusting the effective length of the flexible leash.
